(19) United States
(12) Patent Application Publication
(10) Pub. No.: US 2013/0287261 A1
(43) Pub. Date: Oct. 31, 2013

(54) ELECTRONIC DEVICE AND METHOD FOR MANAGING TRAFFIC FLOW

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 13/854,168

(22) Filed: Apr. 1, 2013

(30) Foreign Application Priority Data
Apr. 25, 2012 (TW) 101114634

(51) Int. Cl. G08G 1/01

(52) U.S. Cl. CPC G08G 1/0145
USPC 382/104

(57) ABSTRACT

A system for managing traffic flow is used in an electronic device in communication with an unmanned aerial vehicle (UAV) and traffic signals. The UAV captures a real-time image of each road, and detects position and direction of the real-time image when the UAV captures the real-time image. The UAV transmits the real-time image of each road, the position, and the direction to the electronic device. The system analyzes the real-time image to gather a number of the vehicles and a number of people in the real-time image. The electronic device marks the number of the vehicles and the number of people on the position of an electronic map corresponding to the position and the direction of the real-time image, and dynamically manages statuses of traffic signals according to the number of the vehicles and the number of people marked on the electronic map.

### BACKGROUND

1. Technical Field

The present disclosure is related to an electronic device and a method for managing traffic flow.

2. Description of Related Art

A traditional method for managing traffic flow is for a traffic police officer to go to a scene of a traffic jam and direct the traffic flow when a traffic jam or a bad road condition occurs. In addition, another traditional method for managing traffic flow is that operators physically go to the scene to manually manage traffic signals for traffic dispersion. These traditional methods need large amounts of work force to manually monitor traffic flow.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic diagram of one embodiment of an electronic device for managing traffic flow.

FIG. 2 is a flowchart of one embodiment of a method for managing traffic flow.

FIG. 3 is a schematic diagram of an unmanned aerial vehicle (UAV) and an image capture unit set on the UAV.

FIG. 4 is a schematic diagram of the UAV of FIG. 3 located on a road for capturing a real-time image of the road.

FIG. 5 is a schematic diagram of image data of vehicles and people in a real-time image of a time of a road.

FIG. 6 is a schematic diagram of a position of a number of vehicles and a number of people marked on an electronic map.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

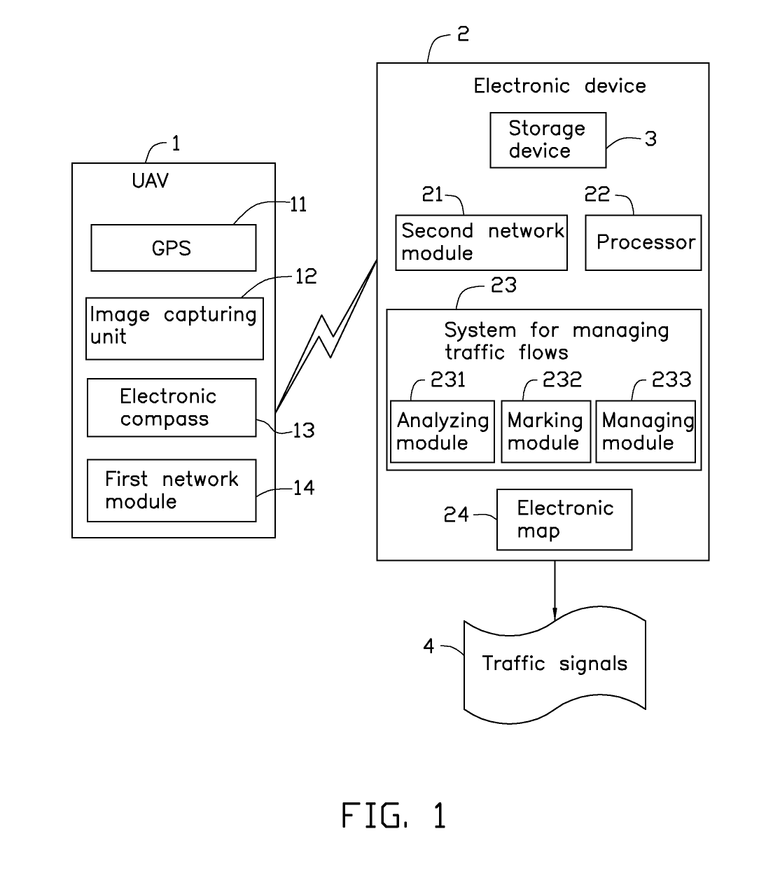

FIG. 1 is a schematic diagram of one embodiment of an electronic device 2 for managing traffic flow. A system 23 for managing traffic flow is used in the electronic device 2 to control traffic signals 4. The traffic signals 4 are light signals alternately changing and are set at an intersection and a special location. The traffic signals are traffic control facilities for allocating the right of way to drivers and pedestrians. The traffic signals 4 include vehicle control signals, pedestrian signals, and special traffic signals, warning tones for the blind, for example.

The electronic device 2 is in communication with an unmanned aerial vehicle (UAV) 1 via a network. The UAV 1 includes a global position system (GPS) 11, an image capturing unit 12, an electronic compass 13, and a first network module 14.

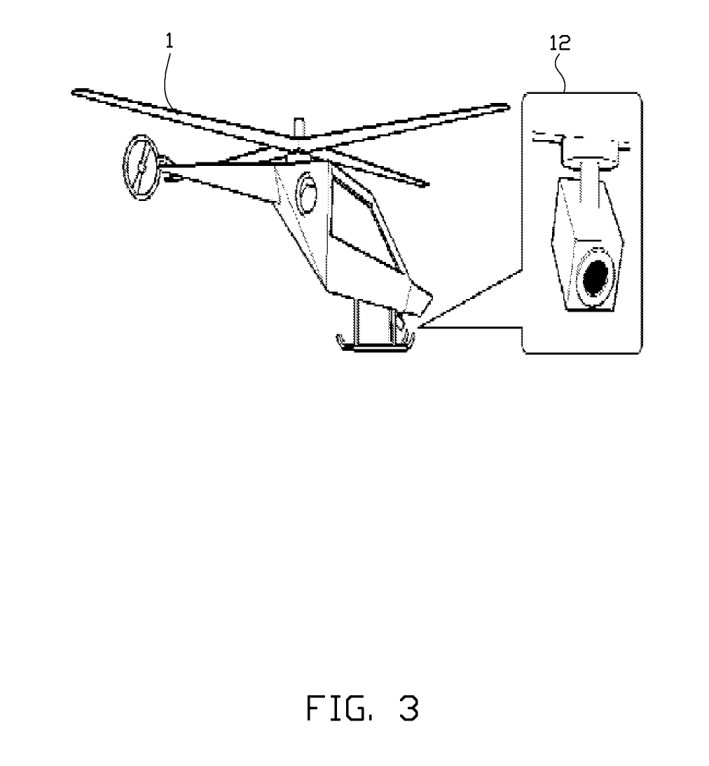

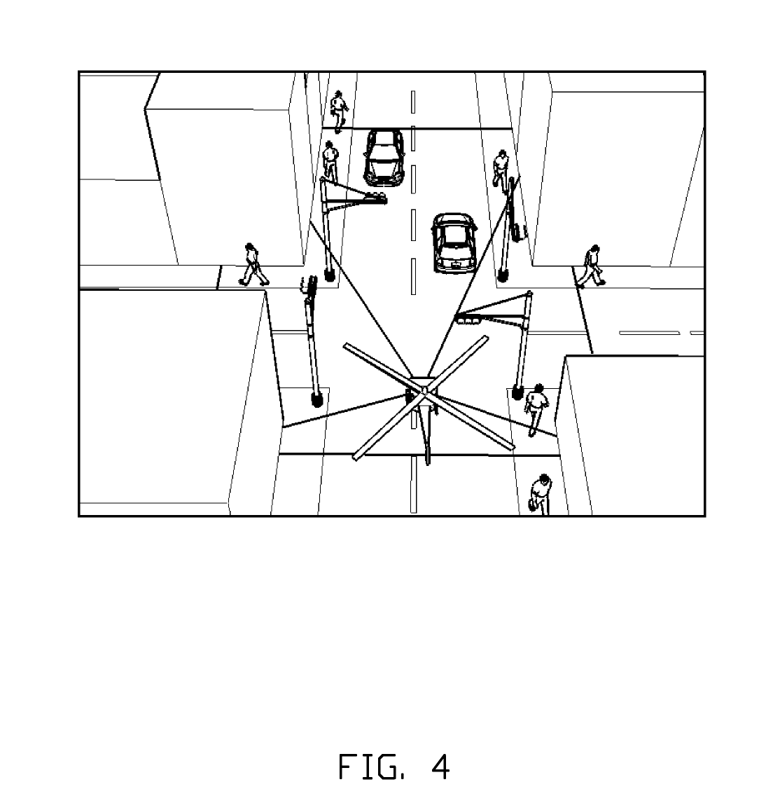

FIG. 3 is a schematic diagram of the UAV 1 and the image capturing unit 12 set on the UAV 1. The image capturing unit 12 is set on a head of the UAV 1, and a direction of a camera lens of the image capturing unit 12 is in accordance with a direction of the head of the UAV 1. In the embodiment, the image capturing unit 12 is a digital infrared camera. The UAV 1 captures a real-time image of each road using the image capturing unit 12. FIG. 4 is a schematic diagram of the UAV located on the road for capturing the real-time image of the road using the image capturing unit 12.

The GPS 11 detects coordinate data. The coordinate data is a location of the UAV 1 when the image capturing unit 12 captures the real-time image. The electronic compass 13 detects direction of the image capturing unit 12 when the image capturing unit 12 captures the real-time image.

The UAV 1 transmits the real-time image, the coordinate data, and the direction to the electronic device 2 via the first network module 14.

FIG. 1 shows that the electronic device 2 includes a second network module 21, a processor 22, and an electronic map 24. The electronic device 2 receives the real-time image transmitted by the UAV 1, the coordinate data, and the direction via the second network module 21, and saves the real-time image, the coordinate data, and the direction into a storage device 3. The storage device 3 may be an internal storage unit of the electronic device 2, or may be an external storage unit connected with the electronic device 2, such as a data server, for example.

The system 23 for managing traffic flow analyzes the data received by the electronic device 2, and analyzes the real-time image by detection technique of vehicles and people to obtain a number of the vehicles and a number of people in the real-time image. The system 23 marks the number of the vehicles and the number of people in a position of an electronic map corresponding to the coordinate data and the direction of the image capturing unit 12. The system 23 further dynamically manages status of traffic signals according to the number of the vehicles and the number of people marked on the electronic map.

The system 23 includes an analyzing module 231, a marking module 232, and a managing module 233. The modules include computerized instructions in the form of one or more programs that are stored in the storage device 3 and executed by the processor 22.

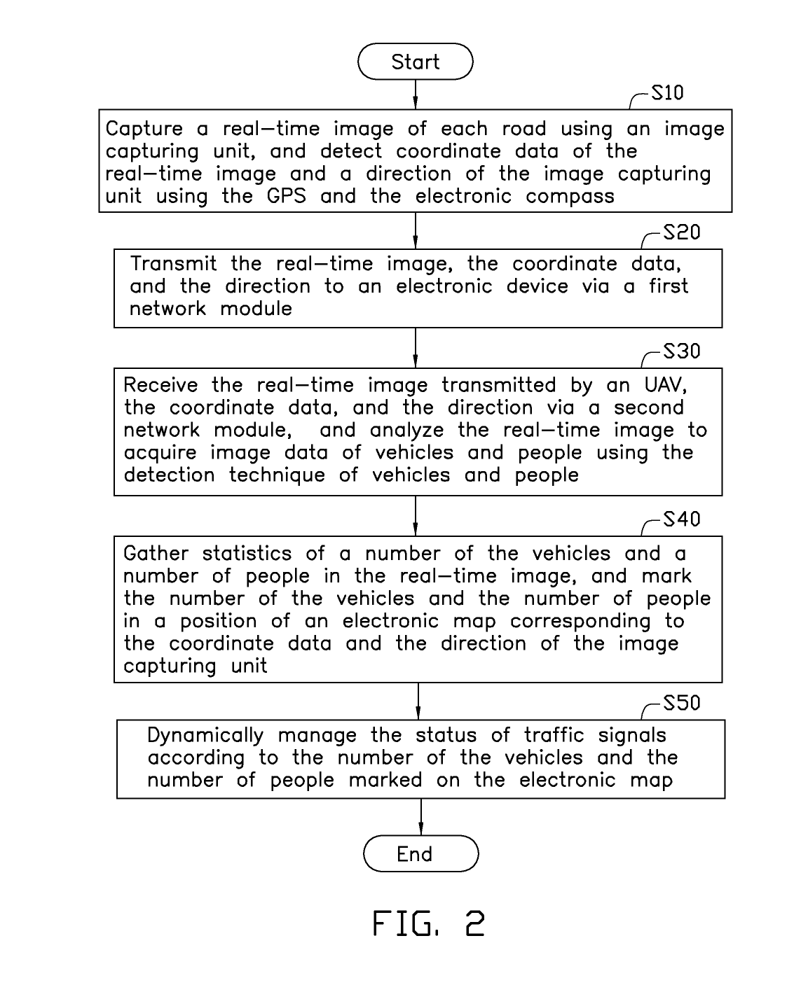

FIG. 2 is a flowchart of the embodiment of the method for managing traffic flow.

In step S10, the UAV 1 captures the real-time image of each road using the image capturing unit 12, and detects the coordinate data of the real-time image and the direction of the image capturing unit 12 using the GPS 11 and the electronic compass 13. FIG. 4 is a schematic diagram of the UAV 1 located on the road for capturing the real-time image of the road. When the UAV 1 captures the real-time image of the road, the GPS 11 detects longitude coordinates of the UAV 1 is 152.6248 and latitude coordinates of the UAV 1 is 25.8214, and the electronic compass 13 detects the direction of the image capturing unit 12 is N-W15°. The first word of the N-W15°, where N indicates that a main direction of the image capture unit 12 is north, and the second word W indicates that a deflective direction of the image capturing unit 12 is west, and the number 15° indicates that a deflective angle from north to west.

In step S20, the UAV 1 transmits the real-time image, the coordinate data, and the direction to the electronic device 2 via the first network module 14.

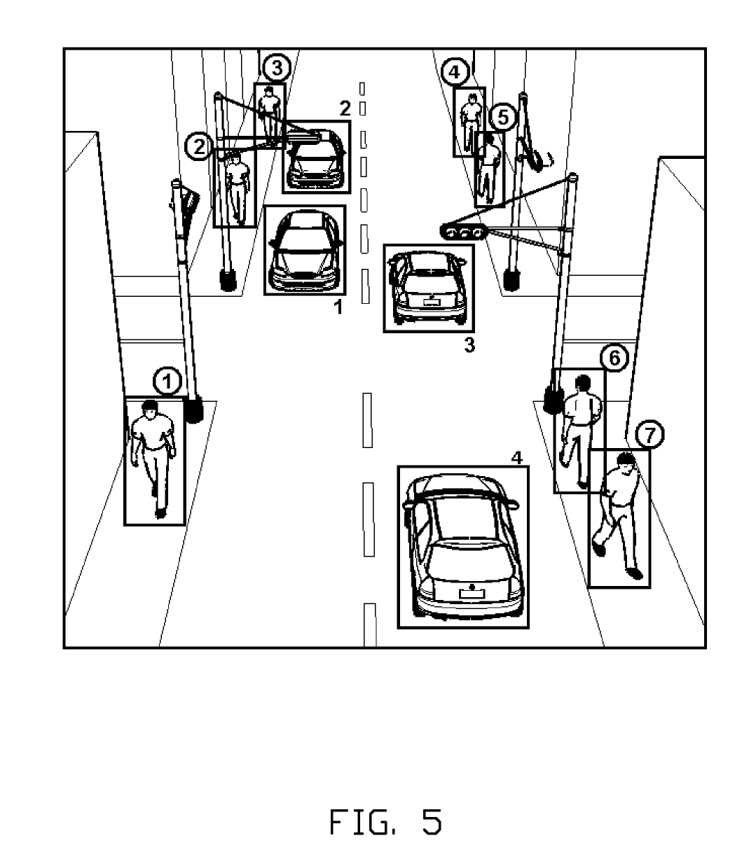

In step S30, the electronic device 2 receives the real-time image transmitted by the UAV 1, the coordinate data, and the direction via the second network module 21. The analyzing module 231 analyzes the real-time image to acquire image data of vehicles and people using the detection technique of vehicles and people. FIG. 5 is a schematic diagram of the image data of vehicles and people in the real-time image of a time of a road. The analyzing module 231 marks image areas of vehicles and people in the real-time image according to a method of rectangles with numbers.

The technique for detecting people includes a statistical method for detecting features of people and a template matching method.

The statistical method for detecting the features of people includes following steps: (1) simplifying a backdrop of the real-time image using an image processing method; (2) matching the real-time image with more than one hundred thousand bits of data of the features of people in a data base; and (3) estimating whether people exist in the real-time image by a number of the features of people that are detected in the real-time image according to a statistical method.

The template matching method includes following steps: (1) collecting a preset number of templates of features of people and a preset number of templates of features that are not people; and (2) training the templates in a method of artificial neural network to continuously fix mistakes, or classify the templates in a method of AdaBoost. The templates after training or classifying can be used for the following tests.

In the embodiment, the vehicles can be detected by the detection technique of vehicles of AdaBoost cascade.

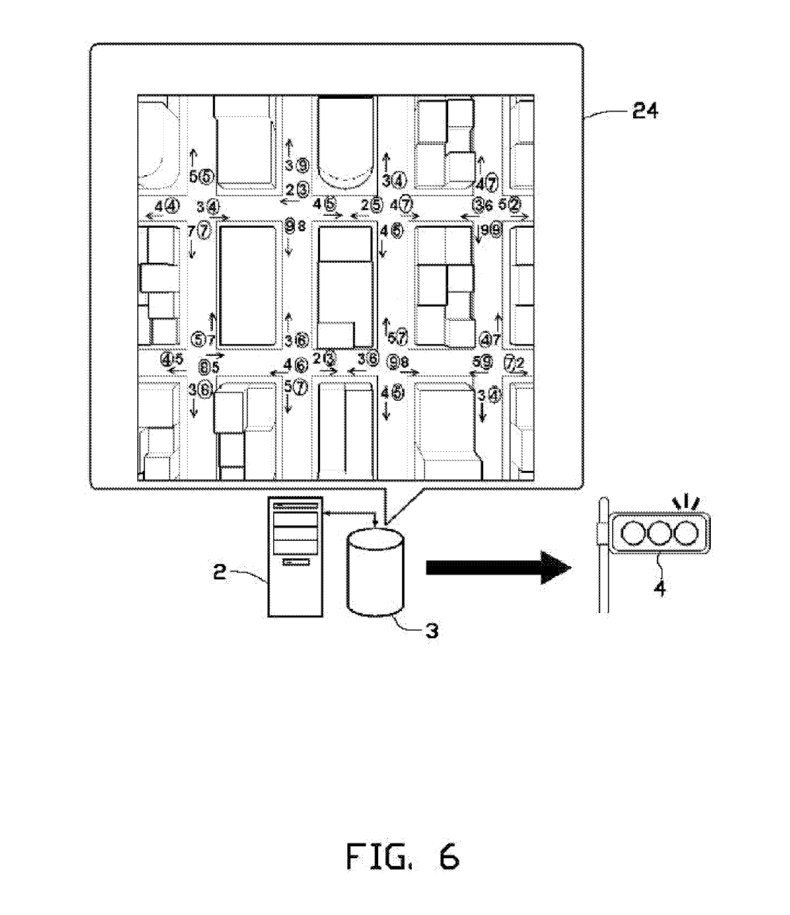

In step S40, the marking module 232 gathers the statistics of the number of the vehicles and the number of people in the real-time image, and marks the number of the vehicles and the number of people in a position of an electronic map 24 corresponding to the coordinate data and the direction of the image capturing unit 12. FIG. 6 shows some areas of the electronic map 24. The electronic map 24 shows marks of roads and buildings. The position of a number of vehicles and a number of people are marked on the electronic map 24 corresponding to the real-time image captured by the UAV 1. The UAV 1 captures one or more real-time images at each crossroad. FIG. 6 is a schematic diagram of the position of the number of vehicles and the number of people marked on the electronic map 24. The electronic map 24 shows arrows of different directions marked at each crossroad. The arrows are the directions of the image capturing unit 12 when the UAV 1 captures the real-time images. Two numbers beside each arrow indicate that the number of the vehicles and the number of people corresponding to the direction of the image capturing unit 12. In the embodiment, a number in a circle indicates the number of people, and a number out of the circle indicates the number of the vehicles.

In step S50, the managing module 233 dynamically manages the status of traffic signals according to the number of the vehicles and the number of people marked on the electronic map 24. For example, when the number of people and the number of the vehicles of a direction of the road exceeds a preset threshold value, the managing module 233 produces a command to the traffic signals of the road for extending transit time of people and vehicles in the direction of the road.

Depending on the embodiment, certain of the steps described may be removed, others may be added, and the sequence of the steps may be altered. It is also to be understood that the description and the claims drawn to a method may include some indication in reference to certain steps. However, the indication used is only to be viewed for identifier purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. An electronic device, comprising:
a storage device;
at least one processor; and
one or more modules stored in the storage device and executed by the at least one processor, the one or more modules comprising:
a network module that receives a real-time image of a road captured by an image capture unit of an unmanned aerial vehicle (UAV) that is in communication with the electronic device, detects coordinate data of the real-time image by a global positioning system (GPS) of the UAV, and detects a direction of the image capture unit using an electronic compass of the UAV;
an analyzing module that analyzes the real-time image to acquire image data of vehicles and people using a detection technique of vehicles and people;
a marking module that gathers statistics of a number of the vehicles and a number of people in the real-time image, and marks the number of the vehicles and the number of people on a position of an electronic map corresponding to the coordinate data and the direction of the image capture unit; and
a managing module that dynamically manages statuses of traffic signals according to the number of the vehicles and the number of people marked on the electronic map.

2. The electronic device of claim 1, wherein the traffic signals are light signals alternately changed, the traffic signals are set at an intersection and a special location, and the traffic signals are traffic controlling facilities for allocating the right of the road to drivers and pedestrians.

3. The electronic device of claim 1, wherein the detection technique of people comprises a statistical method for detecting features of people and a template matching method.

4. The electronic device of claim 1, wherein the statuses of the traffic signals are dynamically managed according to the number of the vehicles and the number of people marked on the electronic map by producing a controlling command for extending passing time of a way of the vehicles and people passing through when a large number of the vehicles and people of the way needs to pass through.

5. A method for managing traffic flow using in an electronic device to control states of traffic signals, the method comprising:
receiving a real-time image of a road captured by an image capture unit of an unmanned aerial vehicle (UAV) that is in communication with the electronic device, detecting coordinate data of the real-time image by a global positioning system (GPS) of the UAV, and detecting direction of the image capture unit using an electronic compass of the UAV;
analyzing the real-time image to acquire image data of vehicles and people by a detection technique of vehicles and people;
gathering statistics of a number of the vehicles and a number of people in the real-time image, and marking the number of the vehicles and the number of people on a position of an electronic map corresponding to the coordinate data and the direction of the image capture unit; and
dynamically managing statuses of traffic signals according to the number of the vehicles and the number of people marked on the electronic map.

6. The method of claim 5, wherein the traffic signals are light signals alternately changed, the traffic signals are set at an intersection and a special location, and the traffic signals are traffic controlling facilities for allocating the right of the road to drivers and pedestrians.

7. The method of claim 5, wherein the detection technique of people comprises a statistical method for detecting features of people and a template matching method.

8. The method of claim 5, wherein the statuses of the traffic signals are dynamically managed according to the number of the vehicles and the number of people marked on the electronic map by producing a controlling command for extending passing time of a way of the vehicles and people passing through when a large number of the vehicles and people of the way needs to pass through.

9. A non-transitory computer-readable storage medium having stored thereon instructions that, when executed by at least one processor of an electronic device, causes the processor to perform a method for managing traffic flow using the electronic device, the method comprising:
receiving a real-time image of a road captured by an image capture unit of an unmanned aerial vehicle (UAV) that is in communication with the electronic device, detecting coordinate data of the real-time image by a global positioning system (GPS), and detecting direction of the image capture unit using an electronic compass of the UAV;
analyzing the real-time image to acquire image data of vehicles and people by a detection technique of vehicles and people;
gathering statistics of a number of the vehicles and a number of people in the real-time image, and marking the number of the vehicles and the number of people on a position of an electronic map corresponding to the coordinate data and the direction of the image capture unit; and
dynamically managing statuses of traffic signals according to the number of the vehicles and the number of people marked on the electronic map.

10. The storage medium of claim 9, wherein the traffic signals are light signals alternately changed, the traffic signals are set at an intersection and a special location, and the traffic signals are traffic controlling facilities for allocating the right of the road to drivers and pedestrians.

11. The storage medium of claim 9, wherein the detection technique of people comprises a statistical method for detecting features of people and a template matching method.

12. The storage medium of claim 9, wherein the statuses of the traffic signals are dynamically managed according to the number of the vehicles and the number of people marked on the electronic map by producing a controlling command for extending passing time of a way of the vehicles and people passing through when a large number of the vehicles and people of the way needs to pass through.
